(19) United States
(12) Patent Application Publication
(10) Pub. No.: US 2005/0108019 A1
(43) Pub. Date: May 19, 2005

(54) Method for performing registration audits

(76) Inventor: Perry L. Johnson, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/500,181

(22) PCT Filed: Dec. 31, 2001
(86) PCT No.: PCT/US01/50028

(51) Int. Cl. G06F 17/60

(52) U.S. Cl. 705/1

(57) ABSTRACT

A method for standards registrars to improve customer service includes value-added auditing (100) in which auditors describe at least two opportunities for improvement (104) to the client or customer seeking registration. This approach is superior to the previous auditing strategies in which the auditors simply listed nonconformities and required the customer to submit corrective actions. In addition, the present invention includes a method for recruitment and training of a registrar's sales force (120) that draws from a larger pool of candidates than traditional approaches by recruiting sales professionals and training them in technical or engineering principles (124) necessary to facilitate quality audits. The present invention also includes a scope extension process (130) for registrar's to expand their scope of accreditation through the use of industry training modules.

### BACKGROUND OF THE INVENTION

1. Field of the Invention

The present invention relates to a methodology for performing various types of audits to certify compliance with a national or international standard.

2. Background

The fierce competition of the 1980s taught American business and industry an unforgettable lesson: Firms that do not provide quality products and services do not thrive, and may not survive. In the 1990s, and on into the 21st century, the definition of quality broadened beyond the caliber of the product or service itself. This extension includes every aspect of providing a product or service, from selling through delivery, to billing and after-sale service.

When choosing suppliers for materials, parts or services, customers at every level, whether industrial, wholesale or retail, need and want a guarantee that they will receive all-around quality. That demand can be met through a comprehensive approach to quality management. As such various national and international organizations have developed series of standards which apply to quality, environmental, occupational health and safety, and other management systems. For example, international and national standards such as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001, have been developed to provide a measure and method for quality management in various industrial and commercial concerns. A standards registrar provides a third-party certification that a particular organization conforms to one or more of such national and/or international standards. As such, standards registrars typically must be recognized or accredited by various national and/or international governmental or quasi-governmental agencies as also possessing a level of competence that the registrar's certification may be relied upon. Examples of such governmental or quasi-governmental agencies include the Registrar Accreditation Board (RAB) in the United States, the RvA of the Netherlands, the UKAS of Great Britain, TGA of Germany, JAB of Japan, and INMETRO of Brazil. As more and more countries and industries recognize the importance of quality standards, the need for certification and registration continues to increase with an associated increase of standards registrars and national and international accrediting bodies.

The word “quality” itself is the cause of much confusion. Quality is defined by the international standards organization (ISO) in ISO 9000:2000, 3.1.1 as the “degree to which a set of inherent characteristics fulfills requirements” and by ISO 8402:1994, 2.1 as the “totality of characteristics of an entity that bear on its ability to satisfy stated and implied needs.” Achieving a satisfactory level of quality involves all activities having an influence on quality.

For the purposes of attaining customer satisfaction, quality means fitness for purpose or fitness of use. Simply stated, it is the ability to meet a given need. Whether the quality of a product or a service is appropriate, depends on the need(s) it is meant to fulfill. For example, the fitting of bathroom floor tiles for the restrooms in a local shopping mall would be determined by quite different standards from tiles meant for the bathroom of a private home. Likewise, a cleaning service used by a laboratory will need to meet different standards from one used by an insurance office. As such, before quality can be determined or judged, it is necessary to understand the measure, which is generally based on the customer's requirements. These requirements are not limited simply to the product or service, however. They encompass all other aspects of the transaction, including price, delivery and its timing, and after-sale service.

The history of quality can be traced as far back as the days of the caveman. A self-sufficient caveman was both a supplier and user. In order to be both, he had to know exactly what was needed, fulfilling the customer requirement, and then became a supplier by creating or manufacturing that item. This common-sense methodology has been passed down through the generations of mankind and is still in practice today. The same concepts can be applied to internal suppliers and customers. Internally, quality also means timely delivery of the product or service required to meet a defined need. The correct and properly made rough castings, for example, must be delivered in the right number to the matching area when they are needed. The company's mail must be correctly sorted and delivered according to schedule, etc.

The chief goal of many businesses is to make a profit for the owner, whether an individual, a partnership or several thousand stockholders, through selling goods or services. Over time, businesses have employed many different strategies to improve their prospects of making a profit. Quality management provides important benefits for customers, but it is even more valuable to the firm. With quality management, companies can improve revenues and cut costs. Superior quality helps companies compete more successfully for new customers. It is also critical in retaining current customers. It is well known that it costs much more—estimates range from 5 to 20 times more, depending on the industry—to attract a new customer than to retain a present one. At the same time, internal efficiency improves, providing additional cost savings. Quality management prevents inefficiencies and the related labor, material, machine, and inventory costs. It also helps a company avoid the costs of delayed payments, reshipment, and repeated service calls. Without question, the quality imperative is healthy for business and industry, consumers and the economy as a whole.

Quality expert Dr. W. Edwards Deming, who introduced quality concepts and processes to the Japanese in 1950 with results that have shaken business and industry worldwide, describes the results of quality achievement as a chain reaction:
Improve Quality—Improve Productivity—Decrease Costs—Decrease Prices—Increase Market Share—Stay in Business—Provide More Jobs—Return of Investment.

Fear, confusion, or excessive optimism are sometimes generated by the prospect of a quality management system or audit. Managers envision loss of decision-making authority, downtime due to excruciatingly thorough inspections, loss of productivity, mountains of paperwork, and huge costs. Workers often fear punitive actions. Conversely, both managers and workers sometimes expect quality management to solve all the company's problems. But quality management is not a cure-all. It can resolve some problems, but it offers no miracle cure. It will do none of the aforementioned things.

Quality auditors are generally not responsible for technical decisions, and quality management auditing is not inspection. While reports are made, paperwork for managers and workers is moderate to minimal. The cost of quality management is relatively small and is normally more than offset by cost savings.

Businesses today are increasingly embracing quality management as a major profit-making strategy. The fact that quality management has become such a prominent strategy in a relatively short time testifies to its extraordinary effectiveness.

As national and international standards increase in number and complexity and are periodically revised, it is necessary for registrars to continue to improve processes for auditing companies for compliance with these standards. Furthermore, recent revisions to the standards emphasize the importance of customer requirements, customer feedback, and customer satisfaction. As a result, companies desiring to obtain a new registration, or to upgrade to the new standard had to modify their quality systems accordingly.

### SUMMARY OF THE INVENTION

The present invention provides a method for standards registrars to improve customer service. In one embodiment, a method for auditing a customer for compliance with a standard includes describing to the client at least two opportunities for improvement. This approach is superior to the previous auditing strategies in which the auditors simply listed nonconformities and expect the customer to address them independently via corrective actions. In addition, to meet the condensed time frames of many customers, a process for 24-hour registration is provided in contrast to the typical six to eight week post-audit process. Furthermore, the present invention provides a method for recruitment and training of a registrar's sales force that draws from a larger pool of candidates than traditional approaches by recruiting sales professionals and training them in technical or engineering principles necessary to facilitate quality audits. The present invention also provides a scope extension process for registrar's to expand their scope of accreditation through the use of industry training modules.

The above features and advantages and other features and advantages of the present invention will be readily apparent to those of ordinary skill in the art based on the following detailed description of the invention and the accompanying drawings.

### BRIEF DESCRIPTION OF THE DRAWINGS

FIG. 1 is a block diagram illustrating one embodiment of an auditing process according to the present invention; and

FIG. 2 is a block diagram illustrating a scope extension process according to one embodiment of the present invention.

### DETAILED DESCRIPTION OF THE PREFERRED EMBODIMENT(S)

The Meaning of Quality Management

The basis of quality management is to satisfy a given need, according to the customer's requirements. That means the basic concern is to make sure that every element of a company, whether it be processes, procedures, systems, or personnel, is geared to furnish: the right product or service, delivery of the product or service to the right customer, delivery at the right time to the right location, delivery of a product or service that meets requirements, delivery of a product or service that satisfies the customer, provision for the appropriate after-sale service, information needed to answer quality-related questions in the context of producer liability, and delivery of all of the above at the negotiated price.

Quality management is vital to all companies. The quality management system any company establishes depends upon its current and targeted markets and their quality requirements. Companies should use applicable requirements when they implement their quality management system.

For any company, quality improvement begins with four basic action steps. The first step is adopting a definition of quality. This includes conforming to requirements, especially those of the customers. The second step is setting up a system to fulfill this defined quality. This is a prevention system that identifies the chances for mistakes and eliminates them. The third step is establishing performance standards. These must be error-free. Defects and errors are neither inevitable nor acceptable. The fourth step is measuring costs. This means calculating the cost of quality by comparing the cost of nonconformities, incurred from not doing it right the first time, such as scrap, rework and lost customers, to the price of conformity, incurred to ensure things are done right the first time.

The issue of detection vs. prevention is the difference between quality control and the quality assurance approach of a quality management system. The former seeks to detect, while the latter tries to prevent nonconformities. Systems with a focus on quality assurance catch nonconformities as they arise in a process. Ideally, they are easier and less costly to remedy at this point. On the other hand, systems with a focus on quality control will let nonconformities go until the end of the process. Once these problems are detected, they are likely much more difficult and costly to fix.

Quality Standards

Quality standards of various types have been in use for centuries. In medieval times, as craftsmen began to band together to form guilds, they created their own standards by which expertise in their various skills was measured. On the user side, quality standards originated out of military necessity. An English king appointed an officer to oversee the production of naval ships nearly a thousand years ago. At about the same time, another official was put in charge of supervising the quality and effectiveness of land-based weaponry and engineering. In recent times, quality standards have continued to be driven by military necessity. In 1912, the British government created an office to ensure the quality of military aircraft. In the United States, quality standards became paramount during and after World War II with the establishment of the MIL STD series of standards. These continued for decades to be the major quality standards imposed upon suppliers to the U.S. Department of Defense.

Quality standards of a non-military nature have matured in more recent years. In the late 1970s, as quality became imperative for many multinational organizations, it became clear that quality of output was directly related to quality of input. Therefore, major firms which relied heavily on suppliers for subassemblies and components began to create their own proprietary quality standards and mandated them to their supply base.

In Europe, the approach to quality standards has followed a somewhat different course. There, the lead on standards has been taken by government rather than by the private sector. Great Britain, for example, codified BS 5750, a set of national quality system standards, in 1979. This standard was made a requirement for suppliers to the government, especially the military, and the full weight and force of the government were placed upon promoting BS 5750 throughout the private sector. The government actively encouraged firms to register. It created an agency which accredited registration bodies and sanctioned another to authorize trainers and courses. The government also publicized BS 5750 to increase awareness and acceptance of the standard among the population.

The European Union (EU) also adopted a quality systems standard, EN-29000, which resembled BS 5750 in many respects. Both EN-29000 and BS 5750 were models for ISO 9000, which was adopted in 1987, and revised in 1994 and 2000. ISO 9000 is used throughout the EU. In ensuing years, the three standards have been harmonized to the point that they are synonymous.

The International Organization for Standardization (ISO), formed in 1946, is a consortium of 132 national standards bodies. The member body representing the United States is the American National Standards Institute (ANSI). Based in Geneva, Switzerland, the International Organization for Standardization created the ISO 9000 quality management systems standard series, which includes ISO 9001:2000, ISO 9001/9002:1994 and Q9000, the American version. ISO 9000 was developed to simplify the international exchange of goods and services through a common set of universally accepted quality standards. ISO 9000, a descendant of BS 5750 and the U.S. military standard MIL-Q-9858A, is a series of standards on quality assurance and quality management. The standards are not specific to products or services, but apply to the processes which create them. The standards were purposely designed to be generic so that they can be used by any industry anywhere in the world. The series specifies goals, objectives and philosophies, but not procedures.

Since its creation, ISO 9000 has served as the building block for many other standards. Its quality management systems derivatives include the U.S. automotive manufacturers' QS-9000, the international automotive standard ISO/TS 16949, the German automotive standard VDA 6.1, the international telecommunications standard TL 9000, the international aerospace standard AS9100, the international medical devices standard ISO 13485, and two QS-9000 derivatives: the Tooling and Equipment (TE) Supplement and the Semiconductor Supplement. Other international and national standards which are similarly structured to ISO 9000 include the environmental management systems standard ISO 14001, the calibration and testing laboratories quality management systems and technical competence standard ISO/IEC 17025, the occupational health and safety management systems standard OHSAS 18001, and the U.S. Food and Drug Administration (FDA) Current Good Manufacturing Practices (CGMP) for medical devices.

Quality Plan

The quality plan (ISO 9001:2000, Element 5.4; ISO 9001/9002:1994, Element 4.2.3) is often a contractual document in which the customer specifies that the supplier take certain quality measures in producing the contracted output. The contents of a quality plan, also known as a control plan, may include inspection plans, design milestones, and critical and/or major subcontractors and requirements. Upon customer approval, the quality plan or control plan becomes an integral part of the contract. When creating a quality plan or control plan, the following activities should be considered, if appropriate: identify and acquire the controls, processes, equipment, fixtures, resources and skills needed to meet quality objectives; verify whether designs, processes, procedures for installation, servicing, and inspection and test activities, and any applicable documentation are compatible with the output (product); update methods for quality control and inspection and testing techniques; when necessary, identify any extraordinary measurement requirements; identify verification activities suitable for both the product and the production process; understand and document standards of acceptability to eliminate any subjectivity; and maintain the required quality records to demonstrate the implementation and effectiveness of the quality management system.

The quality plan or control plan may consist of quality documentation, such as procedures and work instructions, specifying general activities and tasks that must be completed. Documentation serves as the foundation of the quality management system. It is essential to ISO 9000, because it provides objective/audit evidence for the system's status. Documentation also plays a critical role for the quality management system auditor, because it is an invaluable reference resource. It explains the company's policies, defines authority, and establishes operational procedures and work instructions to help employees fulfill their job responsibilities.

When it comes to the quality management system, the documentation is structured like a pyramid. This documentation is divided into four tiers as shown in Table 1.

TABLE 1

| Tier | Documentation Example |
|---|---|
| Tier 1 | Quality Policy and Manual(s) |
| Tier 2 | Procedures |
| Tier 3 | Work Instructions |
| Tier 4 | Quality Records |

The Quality Manual (Tier 1)

The quality manual is considered a top-level document, occupying the top of the quality management system documentation pyramid. It states the company's quality policy and describes the organization's quality management system. Among all of the elements that comprise the ISO 9000 quality management system, none is more important than the quality manual. This controlled circulation document serves a multitude of essential purposes. It is a living, working document meant to be actively used. The quality manual has numerous functions which may include aiding in creating and implementing a quality management system, describing the objectives and structure of the quality management system, demonstrating management's commitment to the system, serving as a cross-reference between the quality management system and ISO 9001:2000, serving as a cross-reference to facility procedures, and serving as a quality management system reference document for auditors and other designated parties, such as registrars, investors and customers, for example. In addition to covering the appropriate sections of ISO 9000, the quality manual can, and usually does, contain a brief statement of the company's commitment to quality, a brief policy statement addressing the company's quality image and reputation, a short company profile aimed at customers and suppliers, a facility mission statement on how the company plans to pursue its quality objectives, a distribution list (controlled circulation), a reference list of facility procedures, and a statement of authority and responsibility.

Procedures (Tier 2)

Procedures are the next level of documentation. They are referred to as Tier 2 documents. A procedure gives information on what activities are conducted in an organization, how they are performed, and who has direct responsibility for them. While the quality manual is a company-wide document, procedures are an extension of the quality manual aimed at different departments. They are activity-based, describing the methods and practices that are used to carry out various quality management system activities that cross functional or organizational lines.

Procedures do not need to be lengthy and redundant. They should be simply written and easy to understand. The ISO 9001:2000 and ISO 9001/9001:1994 standards both state that a facility need only have documented procedures and work instructions. An effective procedure that clearly defines responsibilities will reduce the amount of training needed by new employees. They should be able to perform the task simply by following the procedure.

Work Instructions (Tier 3)

Work instructions fall under the next level of quality documentation, Tier 3. They are directed at the doers of an organization, including the operators carrying out activities in support of the quality management system, and production line workers. While procedures describe an activity, work instructions explain how to do the various tasks specified within a procedure. Work instructions are generally completed by an individual or department. They describe the steps to follow, equipment and resources required for a job, precautionary measures to be taken and other required matters. Work instructions contain specifics, and should be as detailed as necessary to assure clarity and compliance. Since work instructions are “how to” documents, they are likely to change more frequently than the quality manual.

Quality Records (Tier 4)

Quality records are documents that furnish objective/audit evidence that a quality requirement has been fulfilled or demonstrate that the quality management system is operating effectively. These records can be written or stored on any data medium. Records should be kept in a protected place to prevent loss, damage and deterioration. The quality management system should define how long records are to be kept and the disposal method.

Quality Audits

In today's customer-oriented global business environment, improvement measures must be implemented to maintain a competitive edge. Nearly every activity in an organization could benefit from improvement measures, including the processes that monitor the quality of products and services. One effective tool companies can use in their mission of continual improvement is the quality assurance (QA) audit. Since the dawn of the quality age, the term quality audit has come to mean different things to different people.

Objectives of Auditing

Audits have received a bad reputation over the years. The process is often seen by employees and management alike as fuel for retribution or discipline, rather than as an aid which supports error reduction and elimination, compliance, verification, and communication. Audits contribute to achieving many positive objectives. Most importantly: Audits are essential to the process of verifying the performance of a facility's quality management system such that the practice conforms to the applicable standard.

The Audit Team

The Lead Auditor is placed in overall charge of the audit team, which consists of one or more auditors. The audit team should, depending upon circumstances, include experts with specialized backgrounds. The team may include auditor trainees or observers, with the consent of the client, the auditee, and the Lead Auditor.

Nonconformities

According to ISO 9000:2000, 3.6.2 and ISO 8402:1994, 2.10, a nonconformity is nonfulfillment of a (specified) requirement. Nonconformities are classified as either major or minor. Nonconformities may be written as a result of any type of quality audit. When an auditor identifies a nonconformity, he or she must confirm it through objective/audit evidence. Objective/audit evidence is information, such as records or statements of fact about the quality management system, acquired through observation, measurement, test or other means, that can be proven true or are factual in nature.

The ISO 9000:2000 standard, section 3.8.1, defines objective evidence as: “Data supporting the existence or verity of something.” ISO 8402: 1994, 2.19, defines objective evidence as: “Information, which can be proved true, based on facts obtained through observation, measurement, test or other means.” ISO 9000:2000, 3.9.4, defines audit evidence as: “Records, statements of fact or other information which are relevant to the audit criteria and verifiable.” ISO 10011-1:1990, 3.7, defines objective evidence as: “Qualitative or quantitative information, records or statements of fact, pertaining to the quality of an item or service or to the existence and implementation of a quality system element, that are based on observation, measurement, or test, and that can be verified.”

While the finding of a nonconformity often triggers alarm, this should not happen. Nonconformities are not necessarily bad. They identify weaknesses that may be developed into strengths and point out areas where improvements can be made, leading to continual improvement. Nonconformity causes vary. Major nonconformities can be caused by the lack of a procedure or an inconsistency in implementing the quality system. Major nonconformities can greatly affect product or service quality, put the facility or employees at risk of losing customers, jeopardize industry or government certification, and/or cause great harm to other operations in the company. Some examples of major nonconformities include: no documented procedures for contract or design reviews, internal audit reports of remaining system deficiencies with no evidence of follow-up, a considerable number of inspections, measuring and test equipment without current calibration, and drawing or planning changes carried out informally and unapproved in a number of instances.

Other major nonconformities include a single deficiency in the quality management system, product or service, a lack of quality management system documentation to satisfy requirements, quality management system documentation not being implemented consistently, or a series of minor nonconformities indicating an overall quality management system weakness in an area or activity that collectively have significance. Registration cannot be obtained until corrective action has been taken on all major nonconformities.

The lesser degree of a deficiency, minor nonconformities, are those which do not directly affect product or service quality, or are deemed easily rectified. Some examples of minor nonconformities include: isolated examples of drawings marked up with unauthorized design or tolerance changes, isolated examples of instrumentation out of calibration date, evidence of corrective action still outstanding on internal audit nonconformity reports, isolated examples of deficient record keeping on contract or design reviews, and insufficient documentation of training experience gained by employees.

Another example of a minor nonconformity includes situations where a defined quality management system, documented procedures, and work instructions exist, there is an acceptable level of implementation overall, but there are minor discrepancies or lapses in following the quality management system requirements or documentation.

There are two other variations of nonconformities which can also occur: the “vital few” and the “trivial many.” The “vital few” nonconformities can greatly affect quality, though few in number. They usually represent detriments to safety or economics. These may also be chronic problems detected in earlier audits or specifically mentioned by auditees as ongoing concerns. The “trivial many” nonconformities are often minor and occur in great numbers, typically three or more minor nonconformities against one requirement. These can reflect systemic errors and affect quality due to high volume. When applied against a single requirement, the Trivial Many can constitute a major nonconformity.

Nonconformities are cited when the process does not conform to the quality manual or ISO 9000. Nonconformities typically occur when procedures have not been properly implemented. This causes the process to be ineffective.

Observations are another audit classification. An observation is a weakness in existing conditions that, in the auditor's judgment, warrants clarification or investigation to improve the overall status and effectiveness of the quality management system being audited.

As an example, during the course of the audit, objective/audit evidence was inadequate to clearly determine if the quality management system activity being audited was conforming or nonconforming to specified requirements. Observations may signal the potential for future nonconformities, but do not require a response by the auditee.

Recording Nonconformities

Once a nonconformity is found, it must be recorded on a nonconformity report (NCR). The auditor should make sure that the nonconformity report is accurate, concise and easy to read. In the NCR, auditors must list the audit number or identification, audit date, the area under review, the standard referenced, a report of the nonconformity, based on factual statements, and identification of the responsible auditor and the auditee representative. Upon completion, the NCR has to be signed by both the auditor and the auditee representative. This confirms that the auditee is aware of the nonconformity and agrees that corrective action is needed. It is critical that clear, ongoing communication exists between the audit team and the auditee to ensure that no surprises occur at the closing meeting. After the nonconformance has been acknowledged, the Lead Auditor and the auditee need to agree on a date by which corrective action must be completed, as well as any follow-up measures.

Corrective Action and Follow-Up

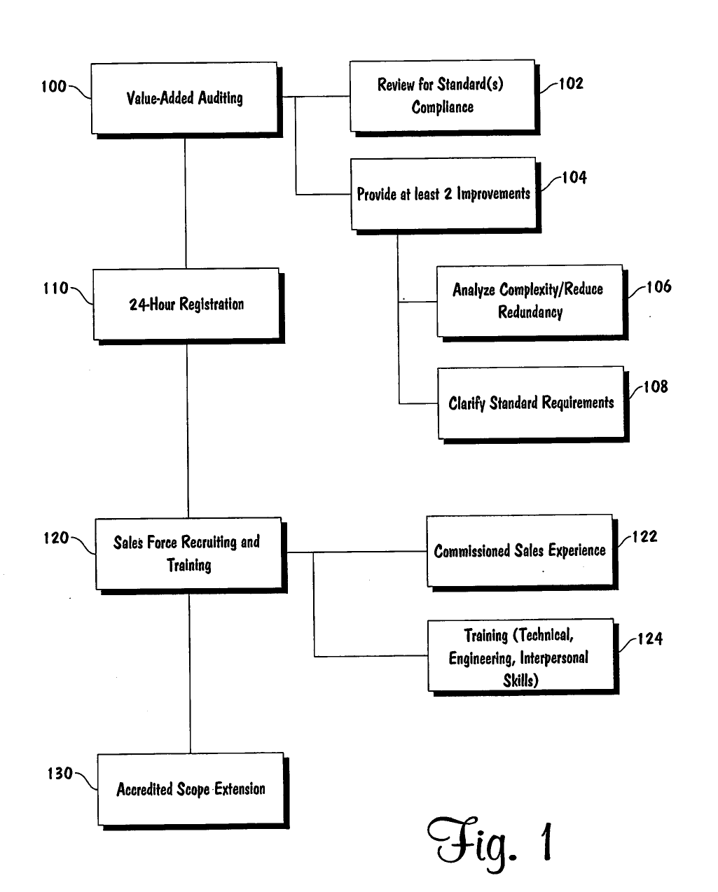

After the quality management system audit has been completed and the final audit report has been submitted, decisions on corrective and preventive actions need to be made by the auditee. The auditors are responsible for identifying nonconformities and documenting them with observations backed up by objective/audit evidence. They should also obtain acknowledgment of the nonconformity from the auditee, during the audit itself or at the closing meeting. In accordance with the present invention as illustrated and described in greater detail with reference to FIG. 1, auditors should make recommendations, however only the auditee can create and implement corrective actions.

It is incumbent upon the audit process, whether first-party (internal), second-party or third-party, to follow up on past nonconformities by evaluating the creation, implementation and effectiveness of corrective actions. Only when corrective actions have been implemented and objectively proven to be effective can a nonconformity be considered eliminated. Actions to eliminate the cause of nonconformities can come from market feedback, customer complaints, management reviews, nonconformity reports, and internal and external audits.

Corrective Action

There are several forms of corrective and preventive actions that may be used to address nonconformities. One is a quick fix correction or a short-term corrective action, sometimes implemented on the spot to mitigate further damage until permanent long-term preventive actions can be implemented. Long-term preventive actions are aimed at eliminating the causes of nonconformities and usually involve changes in procedures and systems. They often take some time to implement because complex process changes are involved.

To facilitate adequate follow up, auditees should carefully document the process of implementing and monitoring corrective and preventive actions. Affected employees should be briefed and, if necessary, adequately trained in corrective action measures, especially if they are responsible for monitoring effectiveness. A written statement of corrective action implementation from the responsible area should be secured. The responsible area management should be contacted to determine why the actions were not taken if a written statement is not received by a predetermined deadline. The auditee should document the corrective action process by completing the second part of the nonconformity report form. This includes a description of the corrective action developed by the auditee, preventive action taken to keep the nonconformity from recurring, and auditee signature in both areas.

Follow-Up

Audits are cyclical activities. Prior audit results are used as reference, and often guidance, when developing the scope and plan of subsequent audits. The findings of an initial audit may also trigger another full-scale or mini-audit to confirm that corrective actions to address specific nonconformities have been implemented. To be effective, the initial audit plan might include the requirements and process for conducting follow-up activities to address nonconformities. Findings that might warrant these activities may be outlined by the audit team, then be communicated to and agreed upon by the auditee and client before the initial audit.

Responsibilities of Auditor and Client

Traditionally, the auditor is responsible only for identifying nonconformities. It was the auditee's responsibility to determine and initiate corrective action. Based on the audit findings, particularly the number of systemic problems, or major or vital few nonconformities discovered, it may be necessary to schedule a follow-up audit. This audit may only review nonconformities and corrective actions or may be full-scale. Determining the necessity and extent of a follow-up audit is the decision of the client, which may depend upon a number of factors, which are determined through the course of an audit.

The impetus for the present invention was the release of a new ISO 9000 standard, ISO 9000:2000 in December of 2000. The new international quality standard had undergone a major revision since the last release, and required a totally new approach to auditing. The new standard focuses more than ever before on customer requirements, customer feedback and customer satisfaction. As a result, companies desiring either to get registered for the first time, or to upgrade to the new standard, had to start making changes in their quality systems.

Dovetailing with the philosophy of the new standard, one feature of the present invention provides an improved auditing method that enhances customer service. The Value-Added Auditing according to the present invention goes beyond the traditional role of the auditor, i.e. checking off the items on the checklist, and writing up any nonconformances. As illustrated in FIG. 1, the present invention provides a method for standards registrars to improve customer service. In this embodiment, a method for auditing a customer for compliance with a standard includes value-added auditing as represented by block 100. This approach is superior to the previous auditing strategies in which the auditors simply listed nonconformities and expected the customer to address them independently via corrective actions. The value added auditing according to the present invention provides that auditors review compliance with the standard(s) as represented by block 102 as was traditionally done. Based on their experience and training, auditors are alert to ways in which they can help the client improve the client's quality system. Auditors step far beyond the compliance/conformance aspects of a company's quality system, digging deeper to truly evaluate its effectiveness. For example, a company's quality system may meet all the requirements and yet be more complex than it needs to be. While not revealing confidential information from other companies, auditors will use the knowledge and judgment gained from close study of many companies' quality systems to point out improvements an auditee can make and preferably provide at least two (2) suggestions for improvements to the client as represented by block 104. For example, auditors can point out areas of redundancy as represented by block 106 and/or clarify the intentions of the applicable standard as represented by block 108 to help improve the flow and sequence of the quality system.

Auditors should be trained in the new ISO 9000:2000 standard and the new approach to auditing. Ongoing training and feedback sessions preferably take place periodically, such as once a month. To reach all auditors efficiently, training sessions may take place via teleconference, for example. The value-added auditing of the present invention preferably also incorporates specific training for all auditors in developing and enhancing interpersonal skills. This aspect of the present invention recognizes that clients may be apprehensive about the audit process, and that pleasant and friendly auditors can do much to alleviate any anxiety they may have.

The suggestions provided by the auditors as part of the value-added auditing process, when implemented, should help clients improve their processes, measurement capabilities, overall efficiency, and profitability.

Following a registration audit, the time frame for most companies to turn in their corrective action or actions, have their registration approved, and receive their registration certificate, is six to eight weeks. However, client feedback indicated that many companies needed to have registration certificates in-hand within a shorter time frame. Whether because of deadlines imposed by a customer, tax reasons, or competitive considerations, these companies required expeditious handling of their audit reports and certificate issuance. To meet the condensed time frames of many customers, a 24-hour registration process was developed as represented by block 110 of FIG. 1. This process provides certification to a national or international standard within 24 hours of a successful compliance audit. The lead auditor may then return to the customer facility on the day following the compliance audit, after the appropriate paperwork is filed and approved, with the registration certificate in-hand. In addition a recognition plaque and banner or flag may be provided. At this point, the customer facility may have an awards ceremony, picture session with management and staff, etc. Due to the expedited handling of the 24-hour registration, an additional cost is imposed to cover additional staffing for the auditor to fully complete the report, rush correspondence with the central location, on-call availability of experts, and advance approval of various documents. In addition, all non-conformances found during the registration audit must be closed to the satisfaction of the lead auditor with final approval granted by the registrar executive committee member or designee. If a major non-conformance is found during the audit, the 24-hour registration may not be applicable. Also, if corrective action requires and warrants implementation to be viewed by the auditor at a later date, the 24-hour registration may not be possible. Although a pre-assessment audit is not required for the 24-hour registration program according to the present invention, it may be beneficial and is typically recommended by the registrar.

A registrar's sales force recruitment and training process, represented by block 120 is also provided. This process provides a method for recruitment and training of a registrar's sales force that draws from a larger pool of candidates than traditional approaches. One goal of the present invention with respect to the sales force is to have representatives located within a 150-mile radius of most major cities serviced by the registrar. To recruit such a large body of sales reps, it is necessary to draw from a larger pool of candidates than that tapped by most registrars. The prior art strategy of registrars generally hires engineering or technical people, then trains them in sales techniques. In contrast, the present invention takes the opposite approach. The number one criterion for becoming a salesperson or account executive according to the present invention requires a candidate to have experience as a commissioned sales representative as represented by block 122. Preferably, successful candidates should have at least four (4) years of experience as a commissioned sales representative. The commissioned part is important because the individual must be motivated to create his or her own income.

Likewise, the sales representatives preferably work on a low base salary, making 80% of their annual income from commissions, residuals and bonuses, for example. This ensures that a high level of motivation is maintained, and that clients are given attentive service. During an initial probationary period, representatives stay in the central office where they can be closely trained and supervised. For the first 120 days, for example, all marketing is accomplished by telephone. Once having successfully completed this training period, the representatives begin going out on personal client visits. Fully trained representatives are encouraged to visit the client as often as necessary to maintain strong interpersonal relationships with them. By recruiting sales professionals and training them in technical or engineering principles, the present invention facilitates broad coverage of many geographic regions while reducing travel related client costs.

The broadening worldwide demand for quality and management system registration has created a gap between demand and supply. The movement has extended far beyond manufacturing and production firms, to construction and mining, all types of service industries including hospitality, computer and other business services, and even the medical field. The list of industries for which registrars are permitted to perform audits is strictly regulated by the various accrediting bodies. Representative accrediting agencies include the RAB in the United States, UKAS of Britain, RvA of the Netherlands, JAB of Japan, TGA of Germany, and INMETRO of Brazil, for example. Each of the accrediting bodies must specifically approve the registrar to audit for each industry classification as determined by the Standard Industrial Code (SIC) in the U.S. or EA code in Europe, or other national or international classification system, for example. The list of industries in which a registrar is approved to perform audits is known as the registrar's scope of accreditation.

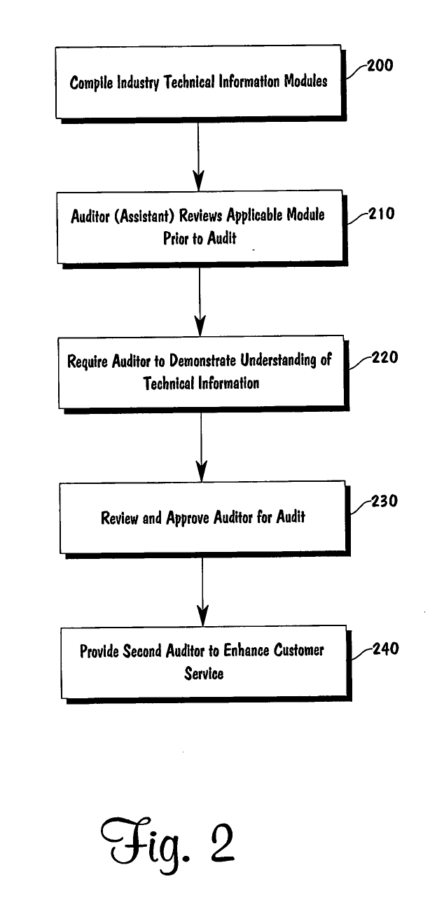

To meet the broadening demand in a variety of industries worldwide, the present invention provides a scope extension process, as represented by block 130 of FIG. 1. The scope extension process allows the registrars to expand their scope of accreditation through the use of industry training modules. The process is illustrated and described in greater detail with reference to FIG. 2.

The international document governing registrars—Guide 62—requires that at least one person on the audit team have experience in the industry being audited. According to one aspect of the present invention, a researcher/technical writer gathers detailed and up-to-date technical industry modules on various industries as represented by block 200. To provide better service to customers, a second auditor (assistant auditor) is assigned to an audit and must review the corresponding industry training module as represented by block 210 in advance of the audit. In addition, the second auditor must take a test to demonstrate an acceptable understanding of the material as represented by block 220. The test is returned to a business coordinator, who checks it against an answer key to make certain the auditor has earned a passing grade as represented by block 230.

In one embodiment, the steps described below must be completed to process a scope extension application. However, due to the fact that each accreditation body has different requirements, the following example may have to be modified accordingly as will be appreciated by those of ordinary skill in the art.

The first step involves the party seeking scope extension to complete a form and forward it to the accreditation representative. The accreditation representative must ensure that the Advisory Board has the proper representation for the new scope extension. If not, a new member of the Board must be added. The current Advisory Board members must approve the new member via a regularly scheduled meeting or a ballot system. The Advisory Board must also approve the scope extension application decision.

A scope extension questionnaire is then sent to the appropriate Advisory Board member. The Advisory Board member must then examine the materials to determine if there is a need to expand the existing checklist or staffing requirements reflected in a man-day grid. The Advisory Board member must also determine if changes need to be made to the Registration Procedures or the Personnel Procedures. The Advisory Board member then returns the questionnaire to the Accreditation Representative. If there is a need for a new checklist, the Accreditation Representative works with the Advisory Board member to prepare one. If additional days need to be added to the man-day grid, a new grid must be created with the additional days recommended by the Advisory Board member. Likewise, necessary changes are made to the registration procedures and personnel procedures. The Accreditation Representative then examines the auditor database to ensure that qualified auditors for the new scope field are included. If not, new auditors with proper experience must be added to the database. The Accreditation Representative must then examine the procedures for the specific accreditation body from which they are seeking the scope extension, and follow those procedures.

A witness audit may be required to obtain a new accreditation or to maintain a current accreditation. The accrediting agency or body may request a witness audit depending upon the particular situation. If requested, the Accreditation Representative studies the requirements for the witness audit and selects available audits from the central database. Search criteria may include time period, SIC code, or type of accreditation (ISO, QS, EMS, TL, AS), for example. Next, the Accreditation Representative will send the list of available audits to the appropriate accreditation body for selection.

The Accreditation Body will respond either with a selection of an audit or will notify the registrar that none of the audits are acceptable. If no appropriate audits can be found, the Accreditation Representative must continue to periodically query the database and repeat the above described steps. Once the accreditation body chooses an appropriate audit, the Accreditation Representative must double check the audit screen in the database and confirm with the Audit Program Coordinator that the audit is still scheduled on the dates given to the accreditation body. If the auditee has canceled the audit, the Accreditation Representative must forward to the accreditation body the written notice from the auditee of the cancellation. If the date has been changed, the Accreditation Representative must send a copy of the new client confirmation letter with the new audit dates on it to the Accreditation Body.

If the audit is still proceeding as scheduled, the Accreditation Representative will confirm the audit with the Accreditation Body and input the words “witness audit” in a corresponding field in the database. The Accreditation Body will provide the registrar with requirements for the necessary materials that need to be sent to the Accreditation Body before, during, and after the audit. Depending upon the particular situation, travel arrangements may need to be made for the auditor(s) from the witnessing body. All necessary paperwork (audit plan, procedures, handbooks) is then sent to the Accreditation Body.

Ten days prior to office audits, the Accreditation Representative must pull previous non-conformance reports and their respective corrective actions to review with a program manager for effective implementation and closure. Proper paperwork must be supplied. For Internal Audits, the Accreditation Representative can follow the Internal Audit procedures. For Accreditation Body audits, the Accreditation Representative will send the Accreditation Body any documents that are requested.

While preferred embodiments of the present invention has been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for auditing a customer for compliance with a quality standard, the method comprising:
reviewing a quality system for compliance with the quality standard;
analyzing the quality system to identify at least two improvements to be made based on knowledge and judgment of an auditor; and
communicating the at least two improvements to the customer.

2. The method of claim 1 wherein the step of analyzing comprises analyzing complexity of the quality system to identify redundancies.

3. The method of claim 2 wherein at least one of the at least two improvements includes a method to reduce the complexity to eliminate redundancy.

4. The method of claim 2 wherein at least one of the at least two improvements includes clarifying the quality standard.

5. The method of claim 1 further comprising requiring auditors to participate in periodic training sessions.

6. The method of claim 5 wherein the auditors participate in the periodic training sessions via video conference.

7. The method of claim 5 wherein the auditors participate in the periodic training sessions via teleconference.

8. The method of claim 5 wherein the training is directed to the quality standard.

9. The method of claim 5 wherein the training is directed to interpersonal skills.

10. The method of claim 1 further comprising:
recruiting sales representatives with commissioned sales experience to solicit customers; and
providing technical and/or engineering training for the sales representatives prior to in-person customer solicitation.

11. The method of 10 wherein the technical and/or engineering training is provided at a central location for a predetermined period of time during which any customer solicitation is performed telephonically.

12. The method of 10 wherein the step of recruiting comprises recruiting sales representatives with at least four years of commissioned sales experience.

13. The method of 1 further comprising:
gathering technical information related to a particular industry classification prior to an audit; and
requiring an auditor to demonstrate an understanding of the technical information related to the particular industry prior to the audit.

14. The method of 13 wherein the step of requiring an auditor to demonstrate an understanding of the technical information includes requiring the auditor to pass a test covering the technical information.

15. The method of 13 further comprising providing an assistant auditor to accompany a primary auditor wherein at least the assistant auditor is required to demonstrate an understanding of the technical information.
